(19) United States
(12) Patent Application Publication
(10) Pub. No.: US 2019/0001593 A1
(43) Pub. Date: Jan. 3, 2019

(54) FIBER COMPOSITES WITH REDUCED SURFACE ROUGHNESS AND METHODS FOR MAKING THEM

(71) Applicant: Dow Global Technologies LLC, Midland, MI (US)

(72) Inventors: Jun Cai, Midland, MI (US); Rainer Koeniger, St. Gallenkappel (CH); David H. Bank, Midland, MI (US); Marsha Langhorst, Midland, MI (US)

(21) Appl. No.: 16/063,587

(22) PCT Filed: Dec. 19, 2016
(86) PCT No.: PCT/US2016/067611

§ 371 Date: Jun. 18, 2018

Related U.S. Application Data
(60) Provisional application No. 62/274,728, filed on Jan. 4, 2016.

(51) Int. Cl. B29C 70/64; B29C 70/48

(52) U.S. Cl. CPC B29C 70/64; B29K 2105/162; B29C 70/48

(57) ABSTRACT

Fiber reinforced composites are made by infusing a mass of reinforcing fibers with a resin composition. The resin composition includes a liquid phase and a small amount of dispersed filler particles. The dispersed filler particles are small in at least one dimension, compared to the diameter of the reinforcing fibers. The resin composition is subsequently hardened to form the composite. This method produces a composite having a very smooth surface. Print-out of the reinforcing fiber is greatly reduced without the need to mask it through the application of thick coatings or additional layers of material.

This invention relates to methods of making epoxy resin composites having reduced surface roughness and methods for making those composites.

Fiber composites are sometimes used to make exterior vehicle body parts or other products that require near surface planarity and smoothness. These composites offer significant advantages in reduced weight compared to metals and in the ability to make complexly shaped parts.

One area in which the fiber composites often fall short is in their surface smoothness. Metals easily form body panels that have highly smooth surfaces that when coated easily produce a glossy appearance.

Fiber reinforced composites have much rougher surfaces, due to the presence of distinct fiber and binder resin phases. Fibers at the surface tend to protrude slightly above the surrounding binder phase, in part due to shrinkage in the resin phase during the manufacturing process. The binder resin phase has a larger coefficient of thermal expansion than the fibers, so when the composite is cooled from the high manufacturing temperatures, the binder phase shrinks away from the surface. In addition, thermosetting binders exhibit some volume reduction as they cure, which also contributes to the surface roughness. These effects contribute to the surface roughness. The pattern of the fibers is clearly visible in the fiber composite, a phenomenon known as “print-through”.

Several approaches have been suggested to overcome this problem. Almost all of these in one way or another provide a show surface overtop of the composite to hide the rough surface. For example, one can simply apply a thick layer of a gel coat, primer or paint onto the surface of the composite. US 2004-0033347 describes such an approach. An encapsulating polymeric coating can be applied, using methods as described, for example, in GB Patent No. 2,408,005A. Similarly, WO 2008/104822 and US 2013-0273295 describe methods of applying a surface finish film to the composite to reduce surface roughness. In WO 2009/147633, a metal surface layer is applied to the same effect.

WO 2008-007094 describes a process in which a show surface having a very high fiber density is applied to a fiber composite. In the process described in US 2005-0095415, separate layers of a thermoplastic material are laminated onto the surface of a composite to produce the smooth surface.

All of the foregoing processes are undesirable because they add significant expense and processing complexity. The added layers can increase part thickness and weight.

U.S. Pat. No. 8,486,321 describes applying a covering layer made up of carbon nanotubes onto the surface of a woven fiber composite to reduce print-through. That process requires the separate fabrication of the carbon nanotube covering layer via a complex process that requires specific orientation of the nanotubes. This adds considerable expense and complexity to the manufacturing process.

Palardy et al., in Optimization of RTM processing parameters for Class A surface finish”, Composites, Part B: Engineering (2008), 39B (7-8), 1280-1286, describes low profile additives mixed in with the resin in a resin transfer molding process to improve surface smoothness in the resulting fiber composite. For example, improved surface smoothness is obtained by adding 20 to 40% by weight of calcium carbonate particles into the resin. The calcium carbonate reduces resin shrinkage. However, large amounts of mineral fillers cause large increases in resin viscosity, which complicates resin handling and makes it difficult for the resin to penetrate fully and uniformly through the fibers. The presence of these high levels of fillers can also cause large changes in mechanical and other properties in the resin phase. Further, calcium carbonate exhibits a high specific gravity, and as such, its use in the manner described by Palardy et al. adds a great deal of mass to the resultant composite.

This invention is a process for making a fiber reinforced composite, comprising applying a resin composition that includes a liquid resin phase to at least one surface of a mass of fibers that have individual fiber diameters of at least 250 nm such that the liquid resin phase of the resin composition permeates into the mass of fibers to form a resin-impregnated fiber mass in which the fiber mass is embedded in the liquid phase of the resin composition, and then solidifying the liquid phase of the resin composition by cooling, curing or both cooling and curing the resin composition to form the fiber reinforced composite, wherein the resin composition has dispersed therein up to 5 volume percent, based on the volume of the resin composition, of filler particles that have at least one dimension smaller than the diameter of the fibers, and further wherein, during the permeation of the liquid phase of the resin composition into the fiber mass, at least a portion of the filler particles becomes concentrated at one or more surfaces of the fiber reinforced composite and reduces the surface roughness of such surface(s) compared to when the resin composition is devoid of the filler particles.

Applicants have found that the presence of small amounts of filler particles in the resin composition causes a large decrease in surface roughness, if the particles are small in at least one dimension relative to the diameter of the fibers. This leads to improvements in the visual appearance of the composite, by reducing print-through and increasing gloss. This eliminates the need to apply separate surfaces layers or very thick primer or coating layers to mask the composite surface.

The low loading of filler particles avoids the problems of resin viscosity increases and large changes in mechanical and other properties of the resin phase. Although the filler particles become concentrated at one or more of the surfaces of the composite, because the filler loading is low in the first instance, there is little change in the composition of the resin phase throughout the thickness of the composite, and therefore mechanical and other properties tend to be highly uniform throughout the composite.

Another advantage of the invention is the improvement in surface characteristics is obtained without adding separate manufacturing steps.

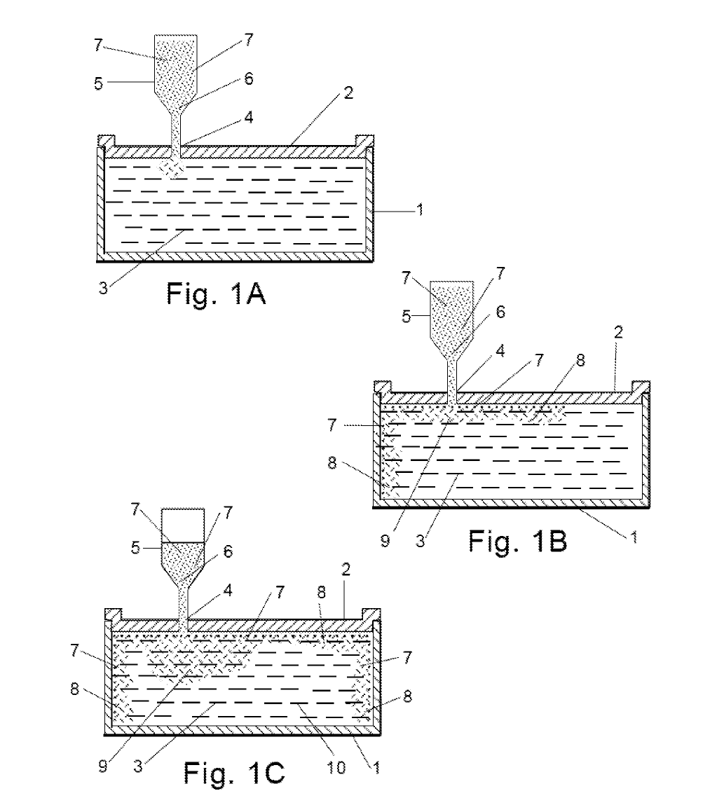

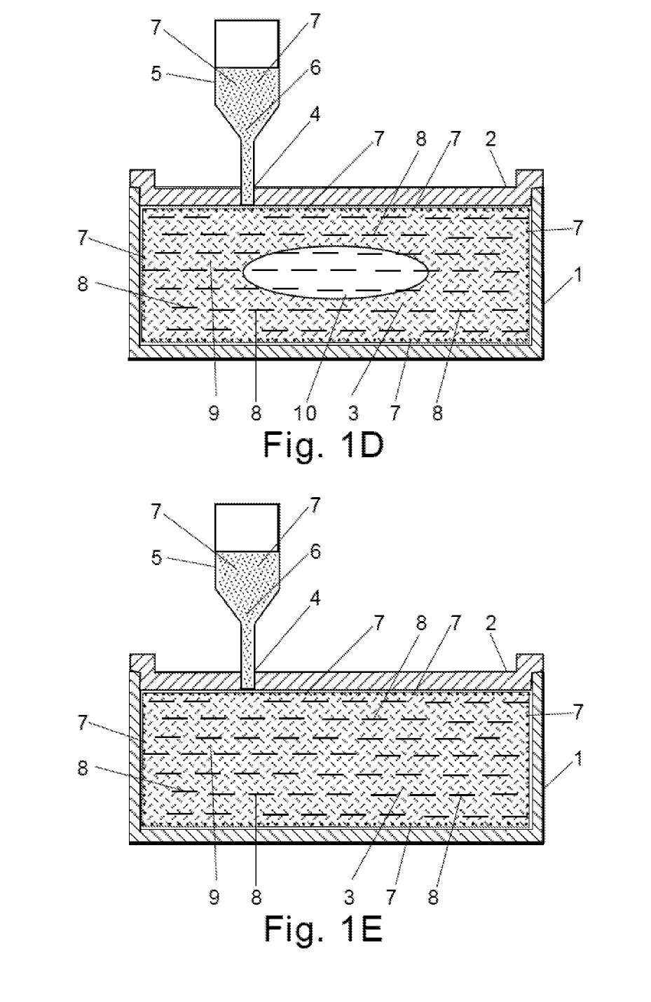

FIG. 1A is a front sectional view of an initial stage of preparing a composition according with an embodiment of the process of the invention.

FIG. 1B is a front sectional view of a subsequent stage of preparing a composition according with the same embodiment of the process of the invention.

FIG. 1C is a front sectional view of a subsequent stage of preparing a composition according with the same embodiment of the process of the invention.

FIG. 1D is a front sectional view of a subsequent stage of preparing a composition according with the same embodiment of the process of the invention.

FIG. 1E is a front sectional view of subsequent stage of preparing a composition according with the same embodiment of the process of the invention.

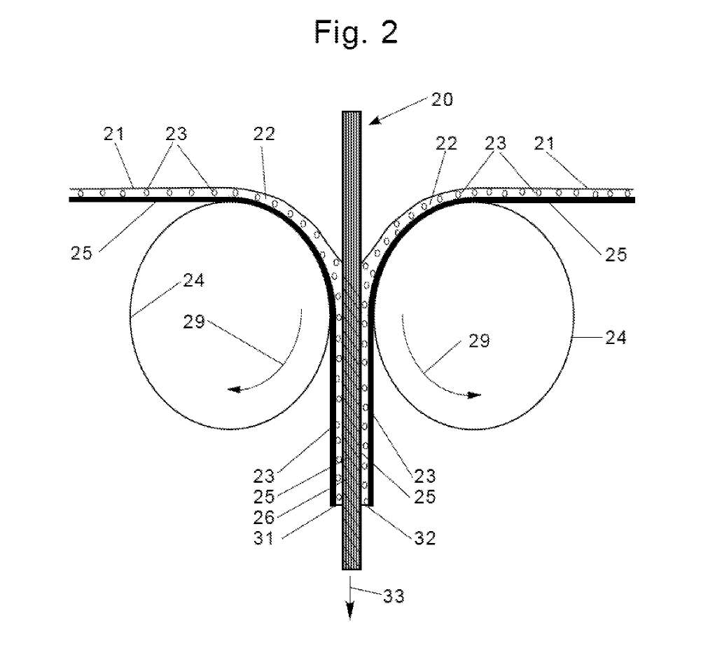

FIG. 2 is a front sectional view of an alternative embodiment of the process of the invention.

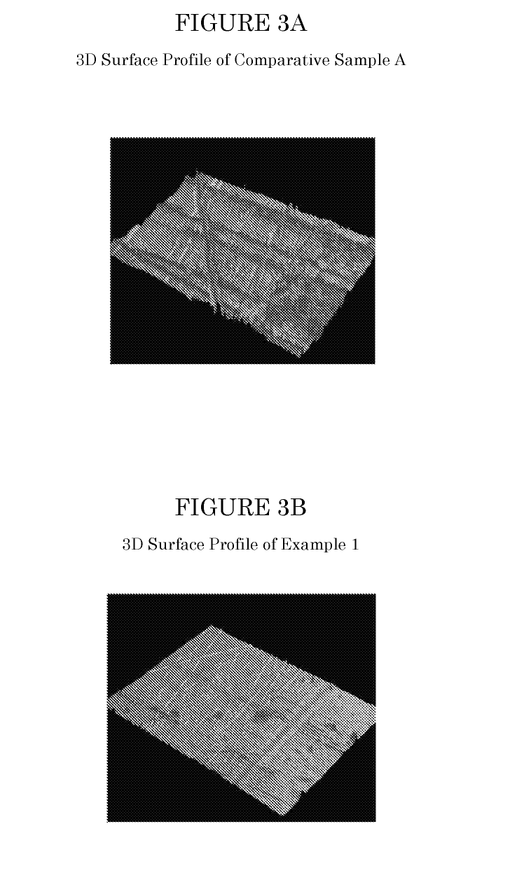

FIG. 3A is a micrograph showing the three-dimensional profile of Comparative Sample A.

FIG. 3B is a micrograph showing the three-dimensional profile of Example 1.

The mass of fibers consists of fibers that have diameters of at least 250 nm. The fiber diameter may be as large as 50 μm. A preferred fiber diameter is 500 nm to 25 μm and a more preferred fiber diameter is 500 nm to 20 μm or 1 to 10 μm. The fiber lengths are greater than the fiber diameter. For purposes of this invention, the fiber diameter is the diameter of a circle having the same area as the cross-sectional area of the fiber. The fibers may be provided in the form of multifilament yarns, rovings or tows; in such cases, the fiber diameter refers to the diameter of the individual filaments in such yarns, rovings or tows, and not to the diameter of the yarns, rovings or tows themselves. Multifilament yarns, rovings and tows may have diameters as great as 1 mm.

The fibers may be made of any material or materials that are thermally and chemically stable under the conditions of preparing and using the fiber-reinforced composite. Examples of useful fibers include carbon fibers, glass and/or other ceramic fibers, mineral fibers such as mineral wool, organic polymer fibers, metal fibers, natural fibers such as wool, cotton, silk, jute and the like, or other fibrous material. Mixtures of fiber types can be used. Specific examples include carbon fibers that contain 60% or more carbon by weight, polyamide fibers, polyester fibers, aramid fibers, basalt fibers, wollastonite fibers, and aluminum silicate fibers.

Especially preferred fibers are provided in the form of multifilament rovings (sometimes referred to as “tows”) having 3000 to 30,000 filaments per roving. These multifilament fibers are most preferably carbon fibers. Examples of such carbon fibers are Aksaca 3K A-38, 6K A-38, 12K A-42, 24K A-42, 12K A-49 and 24K A-49 carbon fibers from DowAksa Ileri Kompozit Malzemeler Sanayi Ltd, Sti, Itanbul, Turkey. These product designations indicate the approximate number of filaments/roving in thousands (3 K being 3000 filaments, for example) and the approximate tensile strength of the fiber in hundreds of MPa (A-38 indicating a tensile strength of 3800 MPa). Other suitable carbon fibers include 12 K and 24 K rovings available from Dost Kimya End Hamm Sen Ve Tic Ltd. Sti, Istanbul, Turkey. The carbon content of these fibers may be 80% or more by weight.

The fibers or yarns, rovings or tows made up of such fibers may be formed into a mat by entangling, weaving, knitting, braiding, stitching, needle-punching or otherwise. The fibers may be aligned in one or more specific directions, or may be randomly oriented. The fibers may be continuous (having lengths, for example, equal to the expanse of the composite in the direction in which the particular fibers are aligned). Alternatively, the fibers may be short fibers having lengths, for example, of at least 1 mm and up to 300 mm, preferably 3 to 150 mm. Such short fibers may be randomly oriented in the fiber mass.

The fiber content of the composite may be, for example, 5 to 95% of the total weight of the composite, i.e., the combined weight of the fibers and the resin phase. Preferred fiber contents are 20 to 90 weight-% or 35 to 70 weight-%, on the same basis.

In some embodiments, the fibers are provided in the form of a mat made of up multiple layers of aligned fibers or rovings. The fibers or rovings in each layer may be woven, knitted or braided, or simply aligned. The multiple layers may be stitched together if desired. Aligned fibers or rovings in the various layers may be oriented in two or more different directions to provide highly isotropic properties or more anisotropic properties, as may be wanted in any particular application. The various layers may be stitched or otherwise held together.

The mass of fibers may have an area density of, for example, 100 to 2000 g/m², 500 to 1000 g/m² or 500 to 750 g/m².

A preferred fiber mat is a woven fiber mat having an area density of 500 to 1000 g/m², especially 500 to 750 g/m², in which the fibers on at least one surface are provided in the form of multifilament rovings having 3000 to 30,000 filaments, especially 12,000 to 24,000 filaments, per roving. Such a preferred fiber mat may include multiple layers of aligned fibers or rovings. The individual layers may all be aligned in the same direction, or may be aligned in two or more different directions. The rovings are most preferably carbon fiber rovings.

At the temperature of application, the resin composition contains a liquid phase, i.e., one or more components that are liquid at the temperature at which the resin composition is applied to the mass of fibers. The liquid phase includes one or more resin components that are capable of solidifying by cooling and/or curing (by themselves or in conjunction with one or more other ingredients of the resin composition) to form a solid resin phase. The liquid phase of the resin composition may, therefore, include one or more molten (i.e., heat-softened and/or melted) thermoplastic resins, and/or one or more liquid polymer precursors that engage in one or more curing reactions to form the resin phase of the composite. In some cases, the liquid phase of the resin composition may contain components that solidify via both cooling and curing mechanisms, whereby, for example, initial solidification is obtained through cooling, followed by curing to form a high molecular weight polymer.

The resin component(s) of the liquid phase are in some embodiments one or more thermoplastic polymers that are room temperature solids. Amorphous thermoplastic polymers suitably have a Vicat B50 (ASTM D 1525) softening temperature of at least 60° C. The softening temperature may be at least 90° C. or at least 120° C. or at least 150° C. If the thermoplastic is a semi-crystalline material which exhibits a crystalline melting temperature, the crystalline melting temperature similarly may be at least 60° C., at least 90° C., at least 120° C. or at least 150° C.

Examples of useful thermoplastic polymers include engineering thermoplastics such as acrylonitrile-butadiene-styrene (ABS) resins; polyamides (nylons) such as nylon 6 and nylon 6,6; polyesters such as polyethylene terephthalate and polybutylene terephthalate; polycarbonates, polyetherketones (PEK), polyetheretherketones (PEEK), polyimides, polyoxymethylene plastics including polyacetals; polyphenylene sulfide, polyphenylene oxide, polysulphones, polytetrafluoroethylene and ultra-high molecular weight polyethylene.

In other embodiments, the liquid phase of the resin composition includes one or more resin components that are liquid (at the temperature of application) and cure to form a polymer that is a room temperature solid. These resin components may be room-temperature liquids. Among this type of resin components are epoxy resin systems that include one or more polyepoxides that are liquid at the application temperature. In such cases, the resin composition will include at least one epoxy curing agent and may include one or more catalysts for the curing reaction, and other, optional components. The epoxy curing agent(s) and catalyst(s) may form part of the liquid phase or may be present in the form of solids at the application temperature, as described more fully below.

Alternatively, the liquid phase may include one or more precursors to polyurethane and/or polyurea polymers. Such precursors include one or more polyisocyanate compounds and one or more curatives that contain multiple isocyanate-reactive groups such as hydroxyl, primary amino and/or secondary amino groups, in each case being liquids at the application temperature. In such cases, the resin composition (but not necessarily the liquid phase) may include one or more catalysts for the reaction between the isocyanate groups and the isocyanate-reactive groups of the curative(s), and may contain other, optional components.

Other useful types of resin components include phenol-formaldehyde resin precursors, melamine resin precursors; polyimide precursors; diallyl phthalate resins; and the like, which are liquid at the application temperature.

The filler particles have at least one dimension, and preferably at least two dimensions, smaller than the diameter of the fibers. The filler particles may have at least one dimension and preferably at least two dimensions that are no greater than 50%, or no greater than 20% than the diameter of the fibers. The third dimension of the filler particles may be substantially greater and may, for example, exceed the diameter of the fibers. The largest dimension may be, for example, up to 100 μm, up to 50 μm or up to 30 μm. In specific embodiments, the filler particles are plate-like particles that have a thickness (smallest dimension) of 1 to 100 nm, especially 5 to 50 nm or 5 to 25 nm, and lengths in the transverse dimensions of up to 100 μm, especially up to 50 μm. In other specific embodiments, the filler particles take the form of nanofibers or nanotubes that have diameters from 1 to 100 nm, especially 5 to 50 nm and 5 to 25 nm, and lengths of 50 nm up to 100 μm, preferably up to 25 am or up to 15 μm. Especially preferred are nanofibers or nanotubes having lengths of 100 nm to 10 μm.

The filler particles are made of materials that are thermally and chemically stable under the conditions of preparing and using the fiber-reinforced composite, such that the filler particles retain their particulate nature. The filler particles therefore do not melt, dissolve, thermally degrade or react in such a way that they lose their identities as individual particulates.

The filler particles can be made of materials as described above with respect to the fibers. The filler particles preferably are made up of a material or mixture of materials that has a bulk density of less than 2 g/cm³, preferably less than 1.5 g/cm³, to minimize weight. Of particular interest are carbon materials such as carbon black, carbon platelets such as graphene and graphene oxide, and carbon nanotubes. Blends of two or more types of filler particles, such as two or more types of carbon filler particles, can be used.

Suitable graphene materials include those sold by XG Sciences as xGnP-H-5, xGnP-H-25, xGnP-M-5, xGnP-M-25 and those sold by Vorbeck Materials Corporation as Vor-x carbon black. These materials have thicknesses of 50 nm or less, more typically in the range of about 5 to 15 nm, and lengths of 50 am or less, more typically in the range of 5 to 25 am. Suitable carbon nanotubes include Graphistrength products sold by Arkema, which have diameters in the range of approximately 5 to 20 nm and lengths in the range of approximately 1 to 10 μm, and NC7000 carbon nanotubes from Nanocyl, which have diameters in the range of approximately 5 to 20 nm and lengths of approximately 1.5 nm.

The filler particles are dispersed in the liquid phase of the resin composition and constitute at most 5 volume percent of the volume of the resin composition (i.e., at most 5 percent of the entire volume of the resin composition including the filler particles). Smaller amounts of filler particles, such as up to 3 volume-%, up to 1 volume-%, up to 0.5 volume-% or up to 0.1 volume-% are more preferred. The filler particles should constitute at least 0.01, preferably at least 0.02 volume-% of the resin composition.

The physical form of the resin composition is that of a liquid phase in which the aforementioned filler particles are dispersed. The resin composition may include other materials that are solid at the temperature of application (i.e., do not form part of the liquid phase). However, the resin composition preferably excludes particulate materials (other than filler particles as described above) that retain their particulate nature in the final composite. Thus, for example, it is preferred that the resin composition excludes filler particles of thermally and chemically stable materials such as carbon, graphite, clays, zeolites and other inorganic materials, metals, ceramics and thermoset polymers, which have a smallest dimension equal to or larger than the diameter of the fibers. In some embodiments, the resin composition excludes thermally and chemically stable filler particles that have a smallest dimension larger than 50% or larger than 20% of the diameter of the fibers.

On the other hand, the resin composition may contain one or more solid (at the application temperature) materials that (via some mechanism such as reaction, melting, dissolution or degradation) lose their particulate identity during the process of manufacturing the composite (including all hardening steps). For example, certain components of a curable resin system may be present in the form of solids when the resin composition is applied. Examples of these include, for example, various curing agents and/or catalysts. Curing agents and/or catalysts may be provided as solid particles to provide a latent, high-temperature cure, for example. This is commonly the case in epoxy resin systems. During the curing steps, these materials melt, dissolve and/or react, losing their particulate nature and in some cases forming part of the resin phase.

The resin composition in some embodiments has a Brookfield viscosity, at the temperature at which it is applied, of no more than 10,000, preferably no more than 3000 mPa·s.

The resin composition may contain various optional ingredients. Optional ingredients include, for example, one or more of the following: a mold release agent; a solvent and/or diluent, a colorant, a toughening agent, a flow modifier, an adhesion promoter, a stabilizer, a plasticizer, a catalyst de-activator, a flame retardant, and mixtures of any two or more thereof.

Generally, the amount of these optional ingredients, if present at all, may be for example, from 0 weight-% to about 70 weight-%, based on the entire weight of the liquid resin composition. These other ingredients, if present at all, may constitute up to 40 weight-%, up to 10 weight-% or up to 5 weight-% of the liquid resin composition.

A highly preferred type of resin composition has a liquid phase that contains one or more epoxy resins. Such a resin composition will also one or more epoxy hardeners and preferably one or more catalysts for the reaction of the epoxy resin(s) and hardener(s). The hardener(s) and catalyst(s) may be present in the liquid phase or in the form of one or more particulate solids.

The epoxy resin is a liquid epoxy resin or a liquid mixture of epoxy resins. The epoxy resin or mixture of resins should contain an average of at least 1.8, preferably at least, two epoxide groups per molecule. The epoxy resin(s) may be aliphatic, cycloaliphatic, aromatic, cyclic, heterocyclic or mixtures thereof. Epoxy resins useful in the present invention include those described, for example, in U.S. Pat. Nos. 3,018,262, 5,137,990, 6,451,898, 7,163,973, 6,887,574, 6,632,893, 6,242,083, 7,037,958, 6,572,971, 6,153,719, and 5,405,688; WO 2006/052727; U.S. Patent Published Patent Applications 2006-0293172 and 2005-0171237, each of which is hereby incorporated herein by reference.

Among the useful epoxy resins are glycidyl ethers of polyphenols. The polyphenol may be, for example, bisphenol; a halogenated bisphenol such as tetramethyl-tetrabromobisphenol or tetramethyltribromobisphenol; a bisphenol such as bisphenol A, bisphenol AP (1,1-bis(4-hydroxyphenyl)-1-phenyl ethane), bisphenol F, or bisphenol K; an alkylated bisphenol; a trisphenol; A; a novolac resin; a cresol novolac resin, a phenol novolac resin; or a mixture of any two or more thereof.

Other useful aromatic epoxy resins include polyglycidyl ethers of aromatic di- and polyamines and aminophenols, polyglycidyl ethers of aliphatic alcohols, carboxylic acids and amines such as polyglycols, polyalkylene glycols, cycloaliphatic polyols, polycarboxylic acids and epoxy terminated oxazolidone resins.

Suitable commercially available epoxy resin compounds include those available from The Dow Chemical Company, such as the D.E.R.™ 300 series of liquid epoxy resins, the D.E.N.™ 400 series of epoxy novolac resins, the D.E.R.™ 500 series, the D.E.R.™ 600 series, the D.E.R.™ 700 series of solid epoxy resins, the DER 858 epoxy terminated oxazolidone resin and VORAFORCE™ epoxy resins.

Each epoxy resin may have an average epoxy equivalent weight of, for example, 100 to 5000, especially 125 to 300 or 150 to 250. An especially preferred epoxy resin most is one or more diglycidyl ethers of a bisphenol having an epoxy equivalent weight of 170 to 225, or a mixture of one or more thereof with one or more epoxy novolac and/or epoxy cresol novolac resins.

Suitable epoxy hardeners include those described in “Chemistry and Technology of the Epoxy Resins” B. Ellis (Ed.) Chapman Hall, New York, 1993 and in “Epoxy Resins Chemistry and Technology”, edited by C. A. May, Marcel Dekker, New York, 2nd edition, 1988. The epoxy hardener(s) may be liquids at the application temperature, or dissolved in one or more other components of the liquid resin composition, but can also be present in the form of a particulate solid. Examples of useful epoxy resin hardeners include aliphatic amines, aromatic amines, hindered cycloaliphatic amines, thiol compounds, phenolic compounds, boron trichloride/amine and boron trifluoride/amine complexes, melamine, diallylmelamine, hydrazides, aminotriazoles, and various guanamines.

Generally, the hardener is present in the epoxy resin composition in an amount sufficient to provide 0.7 to 1.8 equivalents of epoxide-reactive groups per equivalent of epoxide group. In some embodiments, this ratio is 0.9 to 1.3 equivalents of epoxide-reactive groups per equivalent of epoxide groups.

The epoxy resin composition typically will include one or more catalysts such as those described in “Chemistry and Technology of the Epoxy Resins” B. Ellis (Ed.) Chapman Hall, New York, 1993 and in “Epoxy Resins Chemistry and Technology”, edited by C. A. May, Marcel Dekker, New York, 2nd edition, 1988.

The resin composition containing the filler particles is applied to at least one surface of the fiber mass such that the liquid phase of the resin composition permeates into the mass of fibers and fills interstitial spaces between the fibers to form a resin-impregnated fiber mass in which the fiber mass is embedded in the liquid resin composition. The temperature during this step is low enough that the fibers and filler particles do not thermally or chemically degrade during this step, and low enough in the case of a thermosetting resin composition to avoid premature gelation. This temperature may be, for example as low as 0° C. for thermosetting resin compositions. A more typical temperature for thermosetting liquid compositions is 15 to 140° C., especially 15 to 130° C. For thermoplastic resin compositions, temperatures during this step are typically at least 80° C., more typically at least 140° C., and may be as high, for example, as 350° C. or as high as 280° C.

Various industrial processes for making composites, such as pultrusion, prepregging, resin transfer molding, resin transfer molding light, vacuum assisted resin transfer molding, sheet molding compound (SMC), bulk molding compound (BMC), liquid injection molding, and various resin infusion processes such as double bag infusion, controlled atmospheric pressure resin infusion, modified vacuum infusion, resin film injection, resin injection under flexible tooling, Seeman Composites resin infusion molding process, and vacuum assisted resin injection molding are all suitable for the step of embedding the fiber mass in the liquid resin.

In one suitable process, the fiber mass is held in or passes through a cavity into which the resin composition is injected under pressure, contacting one or more surfaces of the fiber mass and penetrating into it. The atmosphere in the cavity may be partially or entirely evacuated before injecting the liquid resin composition. The cavity may be a mold. Such a mold preferably has at least one polished surface for producing a composite having a highly smooth appearance.

In another suitable process, the resin composition can be sprayed or otherwise applied to a bed of the fibers or to a woven or braided fabric.

In another suitable process, the resin composition is filmed onto a release liner and then contacted with a continuous web of tensioned fibers, such as a unidirectionally aligned fibers or fabrics, at heated nip rollers. The pressure of the nip rolls results in infusion of the resin into the fiber web.

Although the invention is not limited to any theory, it is believed that some or all of the filler particles become “filtered” out of the resin composition at or near the surface of the fiber mass, as the liquid phase of the resin composition permeates into the fiber mass. Because the particles are small in at least one dimension, relative to the fiber diameter, the “filtered” particles tend to reside between the fibers at the surface of the fiber mass, at least partially filling those spaces and forming a more uniform, smoother surface. If the fibers are provided in the form of multifilament bundles, rovings or tows, some of the “filtered” particles also tend to reside in the spaces between the multifilaments at the surface of the fiber mass. A thin layer of the particles also may form at the composite surface.

The step of applying the resin composition to the fiber mass preferably is performed such that at least one surface of the fiber mass is coextensive with at least one surface of the resin-impregnated fiber mass, so that there is no separate resin layer on at least that surface. This can be done, for example, by setting the height of the fiber mass equal to the depth of the space in which the fiber mass is held during the step of applying the resin composition.

One embodiment of the infusion process and proposed mechanism are illustrated in FIGS. 1A-1E. In FIG. 1A, fiber mass 3 is contained within a mold defined by mold halves 1 and 2. Resin composition 6 is contained in a delivery system shown generally at 5. Filler particles, some of which are identified by reference numerals 7, are dispersed in the liquid phase of resin composition 6. Delivery system 5 is designed to inject resin composition 6 into the mold via port 4. The size of particles 7 is greatly exaggerated for purposes of illustration, and the number of particles 7 is greatly underrepresented, again for purposes of illustration.

FIGS. 1B-1E illustrate the progress of liquid phase of the resin composition 6 through the mold and into fiber mass 3 as the injection process proceeds. In each of FIGS. 1B-1E, reference numerals 1 through 7 have the same meaning as described with respect to FIG. 1A. FIG. 1B represents an early stage of the injection process, in which resin composition 6 tends to spread along surfaces 8, at the interface between fiber mass 3 and the surfaces of mold halves 1 and 2. Some penetration into fiber mass 3 has begun near injection port 4 and near surfaces 8, producing a resin-infused fiber mass 9 (indicated further with cross-hatching). In FIGS. 1C and 1D, the resin front has spread along surfaces 8 and further into fiber mass 3, producing a larger region of resin-infused fiber mass 9. A region 10 of fiber mass 3 remains unwetted, but as seen in FIGS. 1C and 1D, that region 10 becomes reduced in size as the process proceeds. In FIG. 1E, the entire fiber mass 3 has been wetted with the liquid phase of resin composition 6 so the infused fiber mass 9 is coextensive with fiber mass 3.

As shown in FIGS. 1B-1E, particles 7 tend to become captured at surfaces 8, although some particles 7 may be carried into interior regions of infused fiber mass 9.

An additional embodiment of an alternative infusion process is illustrated in FIG. 2. In FIG. 2, separate films of resin composition 21 are formed onto release liners 25 using a prescribed gap width. Resin composition 21 includes liquid phase 22, into which are dispersed filler particles 23. Resin compositions 21 are applied to fiber mass 20 by passing fiber mass 20 and the films of resin composition 21 between pressurized nip rollers 24, which in the embodiment shown rotate in the directions indicated by arrows 29, pulling fiber mass 20 in the direction indicated by arrow 33. Alternatively, one or both of nip rollers 24 can rotate in the opposite direction from that shown; in such a case, an additional means for moving fiber mass 20 through the nip rollers is generally necessary.

Nip rollers 24 may be heated to a desired infusion temperature, if desired. The pressure applied by nip rollers 24 causes resin composition 21 to infuse into fiber mass 20, forming resin-infused fiber mass 26. Particles 23 become concentrated on surfaces 31 and 32 of resin-infused fiber mass 26. The thickness of surfaces 31 and 32 and the size of particles 23 are greatly exaggerated for purposes of illustration. In a variation of this embodiment, a film of the resin composition is applied to only one side of fiber mass

Yet another suitable embodiment includes a wet compression process in which the resin composition is dispensed on top of the fiber mass in a tool that is subsequently shut. The liquid phase of the resin composition infuses into the fiber mass under the pressure and temperature of the molding process.

Once the fiber mass has been infused with the resin composition, the liquid phase of the resin composition is solidified by cooling and/or curing. Thermoplastic resins are solidified by cooling them to a temperature below their Vicat B50 softening temperature, preferably to a temperature at least 20° C. or at least 40° C. below their Vicat B50 softening temperature. Preferably, thermoplastic resins are solidified by cooling them to a temperature of 40° C. or lower.

Thermosetting resins can be solidified by cooling if the liquid phase of the resin composition is a room temperature solid. If a thermosetting resin composition is a room temperature liquid, it is solidified at least partially by curing. Curing is generally continued until the resin composition attains a glass transition temperature of at least 40° C., preferably at least 55° C. The curing step can be performed at room temperature or an elevated temperature of up to 220° C., as may be suitable for the particular thermosetting resin system.

In some embodiments, a thermosetting resin is only partially cured during the solidification step. Such partial curing is often referred to in the art as B-staging. During B-staging, the thermosetting resin composition is cured enough to form a resin that is solid at room temperature but remains heat-softenable, so the composite can be shaped in a subsequent step by applying heat, followed by performing additional curing to produce a final composite.

The composite can be shaped if desired during the solidification step by, for example, performing the solidification step in a mold or form that imparts a desired geometry to the composite. If the resin composition remains thermoplastic after the solidification step (as when the resin composition is a thermoplastic or the resin composition is thermosetting but is only B-staged during the solidification step), shaping can be performed in a later step by heating the composite to soften the resin phase, performing the shaping step, and then further solidifying the resin by cooling and/or further curing.

The process of the invention is useful, for example, to make vehicle structural and non-structural parts, body panels, deck lids, for automobiles, trucks, train cars, golf carts, all-terrain vehicles, boat hulls and decks, jet-ski hulls and decks, go-carts, farm equipment, lawn mowers and the like. It is useful to make aircraft skins. Other uses include luggage and panels for consumer and industrial appliances, and sporting goods such as hockey sticks, skis, snowboards and tennis rackets.

The following examples are provided to illustrate the invention but are not intended to limit the scope thereof. All parts and percentages are by weight unless otherwise indicated.

### EXAMPLES 1-4 and COMPARATIVE SAMPLE A

Examples 1-4 and Comparative Sample A are made in the following general manner:

Uni-directional carbon fiber fabrics are made with 12K-A42 rovings available from DowAksa, Istanbul, Turkey. The rovings have a weight of 800 g/1000 meters of length and a density of 1.8 g/cm³. The rovings are made of 12,000 individual carbon fibers that each have a diameter of approximately 7 μm. They are manually placed into a two-piece, oil-heated mold with cavity dimensions of 540 mm in length, 290 mm in width, and 2 mm in height, which is held in a 120-ton hydraulic up-stroke press from Wemhöner (model nr. 100 K-120). The height of the fabrics is equal to that of the mold cavity so that the fiber mass extends to the top and bottom surfaces of the resulting composite. The mold is then closed and evacuated, and an epoxy resin formulation injected into the mold cavity under pressure, using a KraussMaffei RSC 4/4 resin transfer molding machine. The epoxy resin formulation contains 100 parts of VORAFORCE 5310 epoxy resin available from The Dow Chemical Company, filler particles (if any) as indicated below, 16 parts of VORAFORCE™ 5350 epoxy hardener available from The Dow Chemical Company and 2 parts of VORAFORCE 5370 internal mold release agent. This amount of epoxy resin formulation is sufficient to produce a solid, void-free composite having the same dimensions as the mold cavity. The mold is then heated to 130° C. for 2 minutes to cure the resin and form a fiber-reinforced composite. The mold is then opened and the composite allowed to cool to room temperature before it is removed from the mold.

The type and amount of filler particles in each case are as indicated in the following table. When filler particles are present, they are mixed into the epoxy resin, and the resulting mixture is sonicated to disperse the filler particles into the resin before the resin is mixed with hardener and internal mold release agent. The Brookfield viscosity of the epoxy resin/filler mixture is measured in each case (except Example 3) at room temperature at 100 rpm using a #3 spindle.

In each case, the surface characteristics of the composite are evaluated by white light interferometry, using a Wyko NT9100 surface profiler equipped with a 50× optical objective lens with a field of view of 127×95 μm. Four surface locations are evaluated for each sample. Surface roughness parameter Rₐ (the area between the surface trace and average profile line) is measured by adding absolute values of height. The surface parameter Rₜ (maximum profile height) is measured as the maximum height between peak and valley for the location analyzed.

TABLE

| | Filler Particles | | | | | |
|---|---|---|---|---|---|---|
| | | Diameter/ | | Resin | | |
| Desig- | | Smallest | Amount, | Viscosity, | Rₐ, | R_{f}, |
| nation | Type | Dimension | vol.-% | cps | nm | μm |
| A* | None | N/A | 0 | 170 | 167 | 6.0 |
| 1 | Carbon | Approx. | 0.05 | 226 | 66 | 1.6 |
| | Nanotubes | 10 nm | | | | |
| 2 | Carbon | Approx. | 0.05 | 719 | 81 | 2.2 |
| | Nanotubes | 10 nm | | | | |
| 3 | Graphene | >50 nm | 0.05 | 203 | 82 | 2.7 |
| 4 | Graphene | >50 nm | 0.11 | N.M. | 82 | 2.4 |
| 5 | Carbon | Up to | 0.54 | 870 | 93 | 4.0 |
| | black | about 1 μm | | | | |

In the Table, lower values of Rₐ and R_{f} are indicative of greater surface smoothness and better visual appearance. Comparative Example A exhibits a surface roughness typical of many fiber-reinforced epoxy resin composites. By adding very small amounts of very small particle size carbon nanotubes and graphene, the values of Rₐ are reduced by half or more, and R_{f} values are reduced by as much as almost 75%. The carbon black provides a significant improvement in both Rₐ and R_{f}, although the improvement is less pronounced than with the other filler particles. The carbon black leads to a greater viscosity increase than do the carbon nanotubes or graphene; this effect may be due to the higher loading of the carbon black.

FIGS. 3A and 3B illustrate the surface characteristics of Comparative Sample A and Example 1, respectively. As can be seen from FIGS. 3A and 3B, surface roughness decreases dramatically with the addition of a very small amount of carbon nanotubes. The results shown in FIG. 3B are typical of Examples 2-4, as well. Example 5 shows surface roughness intermediate to those shown in FIGS. 3A and 3B.

1. A process for making a fiber reinforced composite, comprising applying a resin composition that includes a liquid resin phase to at least one surface of a mass of fibers that have individual fiber diameters of at least 250 nm such that the liquid resin phase of the resin composition permeates into the mass of fibers to form a resin-impregnated fiber mass in which the fiber mass is embedded in the liquid phase of the resin composition, and then solidifying the liquid phase of the resin composition by cooling, curing or both cooling and curing the resin composition to form the fiber reinforced composite, wherein the resin composition has dispersed therein up to 5 volume percent, based on the volume of the resin composition, of filler particles that have at least one dimension smaller than the diameter of the fibers, and further wherein, during the permeation of the liquid phase of the resin composition into the fiber mass, at least a portion of the filler particles becomes concentrated at one or more surfaces of the fiber reinforced composite and reduces the surface roughness of such surface(s) compared to when the resin composition is devoid of the filler particles.

2. The process of claim 1 wherein the resin composition has 0.01 to 1 volume percent of the filler particles dispersed therein.

3. The process of claim 1 wherein the resin composition has 0.02 to 0.1 volume percent of the filler particles dispersed therein.

4. The process of claim 3, wherein the filler particles have at least one dimension that is no greater than 20% of the diameter of the fibers.

5. The process of claim 4, wherein the filler particles are plate-like particles that have a thickness of 5 to 50 nm.

6. The process of claim 5, wherein the filler particles are graphene.

7. The process of claim 4, wherein the filler particles are nanofibers or nanotubes having diameters of 5 to 50 nm and lengths of 50 nm to 100 μm.

8. The process of claim 7 wherein the filler particles are carbon nanofibers or carbon nanotubes.

9. The process of claim 3 wherein the filler particles are carbon particles.

10. The process of claim 3, wherein the liquid resin phase includes at least one epoxy resin.

11. The process of claim 10, wherein the resin composition includes a hardener for the epoxy resin and a catalyst for the reaction of the epoxy resin and the hardener.

12. The process of claim 3, wherein the hardening step includes a step of at least partially curing the resin composition.

13. The process of claim 3, wherein the liquid resin phase includes at least one molten thermoplastic polymer.

14. The process of claim 3, wherein the hardening step includes a step of cooling the resin composition.

15. The process of claim 3 wherein the steps of applying the resin composition to the fiber mass and permeating the liquid resin phase of resin composition into the fiber mass includes the steps of disposing the fiber mass in a mold, closing the mold and injecting the resin composition into the mold.

16. The process of claim 3 wherein the steps of applying the resin composition to the fiber mass and permeating the liquid resin phase of resin composition into the fiber mass includes the steps of forming a film of the resin composition and applying the film to the fiber mass by compressing the film of the resin composition against the fiber mass to infuse the liquid phase of the resin composition into the fiber mass.

17. The process of claim 3 wherein the steps of applying the resin composition to the fiber mass and permeating the liquid resin phase of resin composition into the fiber mass includes the steps of disposing the fiber mass in an open cavity, dispensing the resin composition on top of the fiber mass in the open cavity, closing the cavity and applying pressure.

18. The process of claim 3 wherein the resin composition is devoid of filler particles of thermally and chemically stable materials that have a smallest dimension equal to or larger than the diameter of the fibers.

19. The process of claim 3, wherein the resin composition excludes thermally and chemically stable filler particles that have a smallest dimension larger than 20% of the diameter of the fibers.
